(19) United States
(12) Patent Application Publication
(10) Pub. No.: US 2011/0023046 A1
(43) Pub. Date: Jan. 27, 2011

(54) MITIGATING RESOURCE USAGE DURING VIRTUAL STORAGE REPLICATION

(76) Inventors: Stephen Gold, Fort Collins, CO (US); Jeffrey S. Tiffan, Greeley, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/507,782

(22) Filed: Jul. 22, 2009

(51) Int. Cl. G06F 9/46; G06F 15/173

(52) U.S. Cl. 718/104; 709/223

(57) ABSTRACT

Systems and methods of mitigating resource usage during virtual storage replication are disclosed. An exemplary method comprises detecting quality of a link between virtual storage libraries used for replicating data. The method also comprises determining a number of concurrent jobs needed to saturate the link. The method also comprises dynamically adjusting the number of concurrent jobs to saturate the link and thereby mitigate resource usage during virtual storage replication.

### BACKGROUND

Storage devices commonly implement data replication operations for data recovery. During remote replication, a communications link between a local site and a remote site may have only limited bandwidth (e.g., due to physical characteristics of the link, traffic at the time of day, etc.). When bandwidth is limited, data being replicated may be sent over the link as a plurality of smaller “jobs”. The number of jobs is inversely proportional to the bandwidth. That is, more jobs are sent over lower bandwidth links, and fewer jobs are sent over higher bandwidth links. This is referred to as “saturating” the link and increases replication efficiency.

However, sending more jobs requires more resources (e.g., processing, memory, etc.). For example, each replication job may use CPU and memory to prepare the replication job, such as for compressing data before the data is sent, and/or for establishing/maintaining the link and buffers to transfer the data.

Although a user can manually set the number of concurrent replication jobs, the number of jobs selected by the user may not be optimal for the link quality. Failure to select an optimal number of jobs by the user will result in more resources (e.g., virtual library server CPU/memory) being used than may actually be needed.

### BRIEF DESCRIPTION OF THE DRAWINGS

FIG. 1 is a high-level diagram showing an exemplary storage system including both local and remote storage.

FIG. 2 shows an exemplary software architecture which may be implemented in the storage system for mitigating resource usage during virtual storage replication.

FIG. 3 is a flow diagram illustrating exemplary operations which may be implemented for mitigating resource usage during virtual storage replication.

### DETAILED DESCRIPTION

When replicating virtual storage between two virtual libraries, each concurrent replication job uses virtual library server CPU and memory resources at both ends of the replication link. Since the virtual library servers can also run backup traffic and deduplication processes in addition to replication, it is desirable to mitigate the impact of the replication on the servers to reduce or altogether eliminate the impact that replication has on backup performance, deduplication, or other tasks.

However, the number of concurrent replication jobs that are needed to maximize the bandwidth of the replication link is a variable quantity based on the latency of the link. For example, with a low latency link a 1 Gbit connection may be saturated with just two concurrent replication jobs. But 4 concurrent jobs may be needed to saturate a medium-latency link, and 7 concurrent jobs may be needed to saturate a high-latency link.

Not only does the link latency vary by customer, but link latency can also vary over time (e.g., low latency due to improvements to the link, or higher latency due to alternate network routing due to a failure, etc). Therefore, it is not possible to use a single default number of concurrent replication jobs that will work well with different link latencies.

Instead, systems and methods are disclosed for mitigating resource usage during virtual storage replication. Briefly, a storage system is disclosed including a local storage device and a remote storage device. Data (e.g., backup data for an enterprise) is maintained in a virtual storage library at the local storage device. The data can then be replicated to another virtual storage library at the remote storage device by determining the quality of the link and adjusting the number of jobs in response to the link quality to mitigate (e.g., reduce or even minimize) resource usage.

In exemplary embodiments, a quality detection component is communicatively coupled to a link between virtual storage libraries for replicating data. The quality detection component determines a quality of the link. A job specification component receives input from the quality detection component to determine a number of concurrent jobs needed to saturate the link. A throughput manager receives input from at least the job specification component. The throughput manager dynamically adjusts the number of concurrent jobs to saturate the link and thereby mitigate (e.g., minimize) resource usage during virtual storage replication.

Before continuing, it is noted that non-tape “libraries” may also benefit from the teachings described herein, e.g., files sharing in network-attached storage (NAS) or other backup devices. It is also noted that exemplary operations described herein for mitigating resource usage during virtual storage replication may be embodied as logic instructions on one or more computer-readable medium. When executed by one or more processor, the logic instructions cause a general purpose computing device to be programmed as a special-purpose machine that implements the described operations.

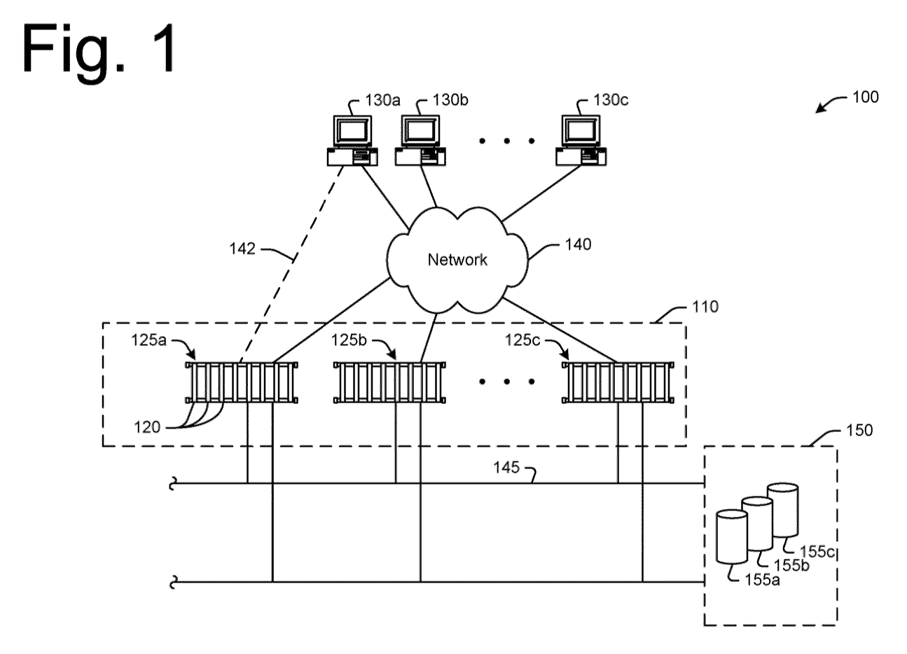

FIG. 1 is a high-level diagram showing an exemplary storage system 100 including both local storage 110 and remote storage 120. The storage system 100 may include one or more storage cells 120. The storage cells 120 may be logically grouped into one or more virtual library storage (VLS) 125a-c (also referred to generally as local VLS 125) which may be accessed by one or more client computing device 130a-c (also referred to as “clients”), e.g., in an enterprise. In an exemplary embodiment, the clients 130a-c may be connected to storage system 100 via a communications network 140 and/or direct connection (illustrated by dashed line 142). The communications network 140 may include one or more local area network (LAN) and/or wide area network (WAN). The storage system 100 may present virtual libraries to clients via a unified management interface (e.g., in a backup application).

It is also noted that the terms “client computing device” and “client” as used herein refer to a computing device through which one or more users may access the storage system 100. The computing devices may include any of a wide variety of computing systems, such as stand-alone personal desktop or laptop computers (PC), workstations, personal digital assistants (PDAs), server computers, or appliances, to name only a few examples. Each of the computing devices may include memory, storage, and a degree of data processing capability at least sufficient to manage a connection to the storage system 100 via network 140 and/or direct connection 142.

In exemplary embodiments, the data is stored on one or more local VLS 125. Each local VLS 125 may include a logical grouping of storage cells. Although the storage cells 120 may reside at different locations within the storage system 100 (e.g., on one or more appliance), each local VLS 125 appears to the client(s) 130a-c as an individual storage device. When a client 130a-c accesses the local VLS 125 (e.g., for a read/write operation), a coordinator coordinates transactions between the client 130a-c and data handlers for the virtual library.

Redundancy and recovery schemes may be utilized to safeguard against the failure of any cell(s) 120 in the storage system. In this regard, storage system 100 may communicatively couple the local storage device 110 to the remote storage device 150 (e.g., via a back-end network 145 or direct connection). In an exemplary embodiment, the back-end network 145 is a WAN and may have only limited bandwidth. Remote storage device 150 may be physically located in close proximity to the local storage device 110. Alternatively, at least a portion of the remote storage device 150 may be “off-site” or physically remote from the local storage device 110, e.g., to provide a further degree of data protection.

Remote storage device 150 may include one or more remote virtual library storage (VLS) 155a-c (also referred to generally as remote VLS 155) for replicating data stored on one or more of the storage cells 120 in the local VLS 125. In an exemplary embodiment, deduplication may be implemented for replication.

Deduplication has become popular because as data growth soars, the cost of storing data also increases, especially backup data on disk. Deduplication reduces the cost of storing multiple backups on disk. Because virtual tape libraries are disk-based backup devices with a virtual file system and the backup process itself tends to have a great deal of repetitive data, virtual tape libraries lend themselves particularly well to data deduplication. In storage technology, deduplication generally refers to the reduction of redundant data. In the deduplication process, duplicate data is deleted, leaving only one copy of the data to be stored. However, indexing of all data is still retained should that data ever be required. Deduplication is able to reduce the required storage capacity.

With a virtual tape library that has deduplication, the net effect is that, over time, a given amount of disk storage capacity can hold more data than is actually sent to it. For purposes of example, a system containing 1 TB of backup data which equates to 500 GB of storage with 2:1 data compression for the first normal full backup.

If 10% of the files change betveen backups, then a normal incremental backup would send about 10% of the size of the full backup or about 100 GB to the backup device. However, only 10% of the data actually changed in those files which equates to a 1% change in the data at a block or byte level. This means only 10 GB of block level changes or 5 GB of data stored with deduplication and 2:1 compression. Over time, the effect multiplies. When the next full backup is stored, it will not be 500 GB, the deduplicated equivalent is only 25 GB because the only block-level data changes over the week have been five times 5 GB incremental backups. A deduplication-enabled backup system provides the ability to restore from further back in time without having to go to physical tape for the data.

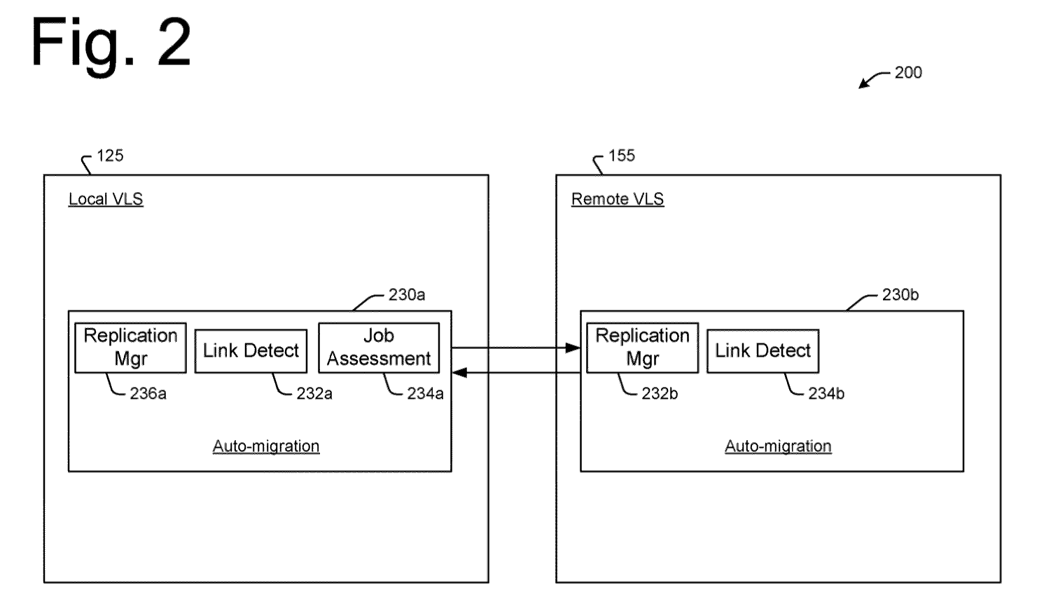

Regardless of whether deduplication is used, the transfer of data from the local storage device to the remote storage device (the “replication job”) may be divided into smaller “jobs” to facilitate network transmission to remote storage. As previously discussed, available bandwidth for transmitting jobs may change dynamically and as such, it is desirable to dynamically adjust the number of jobs being transmitted over the link between the local storage device and the remote storage device. In an exemplary embodiment, dynamic adjustment of the number of jobs in response to link quality may be accomplished by detecting the link quality, determining the number of concurrent jobs needed to saturate the link, and then dynamically adjusting the number of concurrent jobs to saturate the link. Mitigating resource usage as such may be better understood with reference to FIG. 2.

FIG. 2 shows an exemplary software architecture 200 which may be implemented in the storage system 100 for mitigating resource usage during virtual storage replication. The software architecture 200 may comprise an auto-migration component 230a, 230b implemented in program code at each of the local VLS 125 and remote VLS 155. The auto-migration component 230a at the local VLS 125 may be communicatively coupled to the auto-migration component 230b at the remote VLS 155 to handle replication between the local VLS 125 and remote VLS 155.

The auto-migration component 230a may include a link detect module 232a. Link detect module 232a may be implemented as program code for assessing link quality. In an exemplary embodiment, the link detect module 234a at the local VLS 125 may “ping” a link detect module 234b at the remote VLS 155, although it is not required that a link detect module 234b be implemented at the remote VLS 155. In any event, link quality may be based on assessment of the “ping” (e.g., the time to receive a response from the remote VLS 155).

It is noted that link quality may be assessed on any suitable basis. In an exemplary embodiment, link quality may be assessed periodically (e.g., hourly, daily, etc.) or on some other predetermined interval. Link quality may also be assessed based on other factors (e.g., in response to an event such as a hardware upgrade).

Auto-migration component may also include a job assessment module 234a. Job assessment module 234a may be utilized to determine a number of concurrent jobs needed to saturate the link based on the link quality determined by link detect module 232a. In an exemplary embodiment, the number of concurrent jobs may be based on the current link latency.

For purposes of illustration, on a 1 Gbit link, low latency (0-20 ms) may use 2 jobs to saturate, medium latency (50-100 ms) may use 4 jobs to saturate, and high latency (200 ms or more) may use 7 jobs to saturate. It should be noted that the above number of jobs used to saturate the link for various latencies is based on actual test data shown in Table 1. However, the number of concurrent jobs is not limited to being based on this test data.

TABLE 1
Test data for saturating a 1 GB link

| Latency (ms) | Link Throughput | Saturation Data |
|---|---|---|
| 0 | 40 MB/s per stream | 80 MB/s with 2 or more streams |
| 50 | 23 MB/s per stream | 80 MB/s with 4 or more streams |
| 100 | 23 MB/s per stream | 80 MB/s with 4 or more streams |
| 200 | 13 MB/s per stream | 80 MB/s with 7 streams |
| 500 | 7.5 MB/s per stream | 52.5 MB/s with 7 streams |

With regard to Table 1, the test was designed to identify how many streams were needed to saturate a 1 Gbit link at different latencies. Thus, for example, with no latency, each stream can operate at 40 MB/sec, and thus 2 streams are needed to saturate the 1 Gbit link (given that 80 MB/sec is the maximum real world bandwidth of a 1 Gbit link given the overheads of TCP/IP). At a latency of 50 ms, each stream can operate at 23 MB/sec, and thus 4 or more streams would be needed to saturate the 1 Gbit link (again, trying to achieve 80 MB/sec throughput).

The auto-migration components 230a, 230b may also include replication managers 236a, 236b. Replication managers 236a, 236b may be implemented as program code, and are enabled for managing replication of data between the local VLS 125 and remote VLS 155.

In order to replicate data from the local VLS 125 to the remote VLS 155, the replication manager 232a provides a software link between the local VLS 125 and the remote VLS 155. The software link enables data (e.g., copy jobs, setup actions, etc.) to be automatically transferred from the local VLS 125 to the remote VLS 155. In addition, the configuration, state, etc. of the remote VLS 155 may also be communicated between the auto-migration components 230a, 230b.

Although implemented as program code, the replication manager 232a, 232b may be operatively associated with various hardware components for establishing and maintaining a communications link between the local VLS 125 and remote VLS 155, and for communicating the data between the local VLS 125 and remote VLS 155 for replication.

In addition, the replication manager 232a may adjust the number of concurrent jobs. That is, the replication manager 232a issues multiple jobs to “saturate” the link (i.e., achieve full bandwidth). The number of jobs needed to saturate the link may vary and depends on the link quality (e.g., latency). In an exemplary embodiment, the replication manager 232a dynamically adjusts the number of concurrent jobs based on input from the link detect and job assessment modules. The replication manager 232a may adjust the number of concurrent jobs to saturate (or approach saturation of) the link, and thereby mitigate resource usage during virtual storage replication.

It is noted that link detection and job assessment operations may repeat on any suitable basis. For example, the link detect module 232a and job assessment module 234a may be invoked on a periodic or other timing basis, on expected changes (e.g., due to hardware or software upgrades), etc. In another example, the job assessment module 234a may only be invoked in response to a threshold change as determined by the link detect module 232a.

The software link between auto-migration layers 230, 250 may also be integrated with deduplication technologies. In this regard, exemplary embodiments may be implemented over a low-bandwidth link, utilizing deduplication technology inside the virtual libraries to reduce the amount of data transferred over the link.

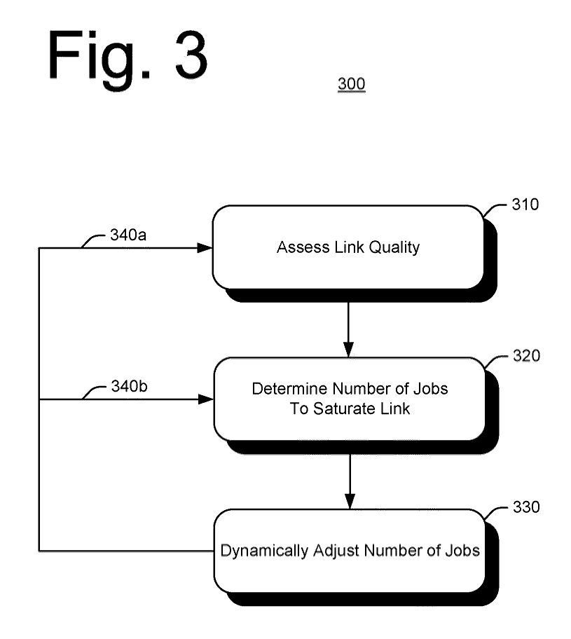

These and other operations may be better understood with reference to FIG. 3. FIG. 3 is a flow diagram 300 illustrating exemplary operations which may be implemented for mitigating resource usage during virtual storage replication.

In operation 310, link quality is assessed. For example, link quality may be assessed by measuring the latency of the replication link. As discussed above, link quality may be assessed using standard network tools, such as “pinging,” or other suitable communication protocol. Also as discussed above, link quality may be assessed on any suitable basis, such as periodically (e.g., hourly, daily, etc.) or on some other predetermined interval and/or based on other factors (e.g., in response to an event such as a hardware upgrade).

In operation 320, a number of concurrent jobs needed to saturate the link may be determined. The number of concurrent jobs may be based on the current link latency. For purposes of illustration, the test data shown in Table 1, above, may be utilized. For example, on a 1 Gbit link, low latency (0-20 ms) may use 2 jobs to saturate, medium latency (50-100 ms) may use 4 jobs to saturate, and high latency (200 ms or more) may use 7 jobs to saturate.

In operation 330, the number of concurrent jobs may be dynamically adjusted to saturate the link and thereby mitigate resource usage during virtual storage replication. Operations may repeat (as indicated by arrows 340a and/or 340b) on any suitable basis, examples of which have already been discussed above.

It is noted that when queuing replication jobs (based on which virtual libraries have been modified and are ready for replication) the queue can limit the number of active jobs on each virtual tape server based on the above algorithm. Note that the larger virtual libraries have multiple virtual library servers within one library, so the queue manager may dynamically control the maximum number of concurrent replication jobs per server and evenly distribute the jobs across the servers based on these job limits per server.

It is noted that dynamically adjusting the number of jobs being issued over the link in response to link quality, such as just described, may be initiated based on any of a variety of different factors, such as, but not limited to, time of day, desired replication speed, changes to the hardware or software, or when otherwise determined by the user.

It is noted that the exemplary embodiments shown and described are provided for purposes of illustration and are not intended to be limiting. Still other embodiments are also contemplated for mitigating resource usage during virtual storage replication.

1. A method comprising:
detecting quality of a link between virtual storage libraries used for replicating data;
determining a number of concurrent jobs needed to saturate the link; and
dynamically adjusting the number of concurrent jobs to saturate the link and thereby mitigate resource usage during virtual storage replication.

2. The method of claim 1, wherein the link is between a local virtual storage library and a remote virtual storage library.

3. The method of claim 1, wherein saturating the link includes maximizing bandwidth on the link.

4. The method of claim 1, wherein dynamically adjusting is with respect to time.

5. The method of claim 1, wherein dynamically adjusting is in response to detecting a change in the quality of the link.

6. The method of claim 5, wherein the detected change is based on a threshold value.

7. The method of claim 1, wherein detecting the quality of the link is based on measuring latency over the link.

8. The method of claim 7, wherein link latency is based on at least one of time of day, network traffic, network routing, and network speed.

9. The method of claim 1, further comprising selecting the number of jobs to send over the link from between one to seven jobs.

10. A system comprising:
a quality detection component communicatively coupled to a link between virtual storage libraries for replicating data, the quality detection component determining a link quality;
a job specification component receiving input from the quality detection component to determine a number of concurrent jobs needed to saturate the link; and
a throughput manager receiving input from at least the job specification component, the throughput manager dynamically adjusting the number of concurrent jobs to saturate the link and thereby mitigate resource usage during virtual storage replication.

11. The system of claim 10, wherein the link is between a local virtual storage library and a remote virtual storage library.

12. The system of claim 10, wherein the throughput manager increases bandwidth on the link by saturating the link.

13. The system of claim 10, wherein the throughput manager dynamically adjusts the number of concurrent jobs with respect to time.

14. The system of claim 10, wherein the throughput manager dynamically adjusts the number of concurrent jobs in response to the quality detection component detecting a change in link quality.

15. The system of claim 14, wherein the detected change is based on a threshold value.

16. The system of claim 14, wherein the quality detection component detects the change in link quality based on measured latency over the link.

17. The system of claim 16, wherein link latency is based on at least one of time of day, network traffic, network routing, and network speed.

18. The system of claim 10, wherein the throughput manager selects the number of jobs to send over the link from between one to seven jobs.

19. A system for mitigating resource usage during virtual storage replication comprising:
local and remote virtual storage means for replicating data;
means for detecting link quality between the means for replicating data; and
means for dynamically adjusting the number of concurrent jobs in response to detecting a change in the quality of the link to saturate the link.

20. The system of claim 19 further comprising means for determining, a number of concurrent jobs needed to saturate the link.
